(19) United States
(12) Patent Application Publication
(10) Pub. No.: US 2016/0109093 A1
(43) Pub. Date: Apr. 21, 2016

(54) LIGHTING DEVICE, LIGHTING KIT AND LUMINAIRE

(71) Applicant: KONINKLIJKE PHILIPS N.V., Eindhoven (NL)

(72) Inventors: Ya-Kuang HSIAO, Sindian City (TW); Lei SUI, Shanghai (CN); Huaizhou LIAO, Shanghai (CN); Hai Tao LIU, Shanghai (CN)

(73) Assignee: Koninklijke Philips N.V., Eindhoven (NL)

(21) Appl. No.: 14/779,833

(22) PCT Filed: Mar. 26, 2014
(86) PCT No.: PCT/IB2014/060152

§ 371 Date: Sep. 24, 2015

(30) Foreign Application Priority Data
Mar. 26, 2013 (CN) PCT/CN2013/073171
Aug. 30, 2013 (CN) PCT/CN2013/001022

(51) Int. Cl. F21V 7/00; F21V 7/06; F21V 7/08

(52) U.S. Cl. CPC F21V 7/0008; F21V 7/0058; F21V 7/08; F21V 7/06; F21Y 2101/02

(57) ABSTRACT

Disclosed is a lighting device comprising a solid state lighting element (20, 21, 101,102); a reflective arrangement (10) for reflecting luminous output of the solid state lighting element, the reflective arrangement comprising: a reflective conical central section (12) on a central axis of the lighting device; and an annular reflective body around the reflective conical central section, said body comprising an ellipsoid surface (14) having a first focal point lying inside the reflective conical central section and a second focal point, wherein the solid state lighting element is located at the second focal point; wherein the reflective conical central section (12) is movably mounted along said central axis. A lighting kit and luminaire including such a lighting device are also disclosed.

### FIELD OF THE INVENTION

The present invention relates to a lighting device comprising lighting device comprising a solid state lighting element and a reflective arrangement for reflecting luminous output of the solid state lighting element.

The present invention further relates to a lighting kit including such a lighting device.

The present invention yet further relates to a luminaire including such a lighting device.

### BACKGROUND OF THE INVENTION

With a continuously growing population, it is becoming increasingly difficult to meet the world's energy needs as well as to control carbon emissions to kerb greenhouse gas emissions that are considered responsible for global warming phenomena. These concerns have triggered a drive towards more efficient energy solutions in an attempt to reduce energy consumption.

One such area of concern is lighting applications, either in domestic or commercial settings. There is a clear trend towards the replacement of traditional incandescent light bulbs, which are notoriously energy inefficient, with more energy efficient replacements. Indeed, in many jurisdictions the production and retailing of incandescent light bulbs has been outlawed, thus forcing consumers to buy energy-efficient alternatives, e.g. when replacing incandescent light bulbs.

A particular promising alternative is provided by solid state lighting (SSL) devices, which can produce a unit luminous output at a fraction of the energy cost of incandescent light bulbs. An example of such a SSL element is a light emitting diode.

A drawback of SSL element-based lighting devices is that individual SSL elements have a much lower luminous output than e.g. incandescent, tungsten halogen or fluorescent light bulbs, such that it is necessary to include multiple SSL elements in a single light bulb to obtain the required luminous output levels.

However the foot print of the device, e.g. a light bulb, is a limiting factor in how many SSL elements can be integrated into a single device such as a GU10 or MR16 light bulb. In addition, it is far from straightforward to create a focused or collimated beam angle with such SSL element-based lighting devices, as the SSL elements tend to generate their output over wide angles, which may compromise the perceived quality of light produced by the SSL element-based lighting device.

A lighting device according to the opening paragraph is known from U.S. Pat. No. 8,083,379 B2, in which multiple LEDs are placed in the respective second focal points of ellipsoid mirrors. The first focal points of the ellipsoid mirrors coincide in a further concave mirror, which redirects light of a collimated nature through a central aperture in the array of ellipsoid mirrors. A drawback of this device is that the aperture has to be formed in the ellipsoid mirrors, which increases the complexity and cost of the lighting device. In addition, the design of this device does not facilitate an increase of the number of LEDs in the design, such that the luminous intensity of this lighting device is insufficient for certain application domains.

A further drawback is that different lighting applications typically require different lighting characteristics such as beam angles produced by the lighting device. This typically requires the redesign of beam shaping elements such as reflectors, which adds to the cost of SSL element-based lighting devices. The cost of such devices is considered prohibitive for mass market penetration such that there exists a need to reduce the cost of such lighting devices.

### SUMMARY OF THE INVENTION

The present invention seeks to provide a more cost-efficient lighting device capable of producing a collimated light output.

The present invention further seeks to provide a lighting kit including such a lighting device.

The present invention yet further seeks to provide a luminaire comprising such a lighting device.

According to an aspect, there is provided a lighting device comprising a solid state lighting element; a reflective arrangement for reflecting luminous output of the solid state lighting element, the reflective arrangement comprising a reflective conical central section on a central axis of the lighting device; and an annular reflective body around the reflective conical central section, said body comprising an ellipsoid surface having a first focal point lying inside the reflective conical central section and a second focal point, wherein the solid state lighting element is located at the second focal point; and wherein the reflective conical central section is movably mounted along said central axis.

The present inventors have realized that by providing a reflective element in which ellipsoid surfaces are radially positioned around a reflective conical central section including the first focal points of these ellipsoid surfaces, an exit window may be provided opposite the reflective element, thereby simplifying the manufacturing of the lighting device and reducing its manufacturing cost. Moreover, by ensuring that the reflective conical central section can be moved along the central axis, the degree of collimation provided by the reflective conical central section can be varied, thus obviating the need for a complete redesign of the reflective arrangement for different application domains. Instead, characteristics such as the beam angle produced by the lighting device may be altered by adjusting the position of the reflective conical central section relative to the annular reflective body.

The annular reflective body may comprise a screw nut on the central axis, and the reflective central conical section may comprise a screw shaft mating with said screw nut. Alternatively, the annular reflective body may comprise a first threaded surface portion facing the central axis and the reflective conical central section may comprise a second threaded surface portion engaging with the first threaded circuit portion, the reflective conical central section further comprising an attachment mounted inside the reflective conical central section for twisting the reflective conical central section. These example embodiments can be manufactured in a particularly cost-effective manner and allow for a straightforward adjustment of the relative position of the reflective central conical section.

In an embodiment, the reflective conical central section has a conic constant in the range of −0.7 to −1.3. By selecting the conic constant of the reflective conical central section in the range from −0.7 to −1.3, a particularly collimated output may be generated in which the degree of collimation, i.e. the beam angle of the lighting device, may be controlled by the choice of the conic constant. It is noted that the conic constant is also known as the Schwarzschild constant.

The reflective conical central section may have a convex surface such as a parabolic surface. It has been found that the combination of the radial array of ellipsoid reflective surfaces and a paraboloid reflective conical central section yields a lighting device having particularly good collimation, i.e. a particularly small beam angle.

In an embodiment, the annular reflective body comprises an annular array of reflective ellipsoid surfaces extending radially from said reflective conical central section, each reflective ellipsoid surface having a first focal point inside the reflective conical central section and a second focal point; and the lighting device comprises a plurality of solid state lighting elements, each solid state lighting element being located at a respective one of said second focal points and arranged to emit light towards said reflective ellipsoid surface. This has the advantage that a higher number of solid state lighting elements can be integrated in the lighting device, thereby improving the intensity of the luminous output of the lighting device.

The annular reflective body may comprise an array of ellipsoid bodies, each body comprising one of said reflective ellipsoid surfaces and a further reflective ellipsoid surface opposite the reflective ellipsoid surface, said further reflective ellipsoid surface creating a first focal point inside the reflective conical central section and a second focal point; the lighting device further comprising a solid state lighting element located at the second focal point of each of the further reflective ellipsoid surfaces and arranged to emit light towards said further reflective ellipsoid surface. This achieves a lighting device producing a luminous output of excellent intensity.

The ellipsoid bodies may be angled relative to a plane perpendicular to said central axis.

In another embodiment, the annular reflective body further comprises an annular array of further ellipsoid bodies angled relative to said plane, the ellipsoid bodies and further ellipsoid bodies being on opposite sides of said plane, each further ellipsoid body comprising a first reflective ellipsoid surface creating a first focal point inside said reflective conical central section and a second focal point; and a second reflective ellipsoid surface opposite the first reflective ellipsoid surface, said second reflective ellipsoid surface creating a first focal point inside said reflective conical central section and a second focal point; the lighting device further comprising: a solid state lighting element located at the second focal point of each of said first reflective ellipsoid surfaces and arranged to emit light towards said first reflective ellipsoid surface; and a solid state lighting element located at the second focal point of each of said second reflective ellipsoid surfaces and arranged to emit light towards said second reflective ellipsoid surface. This achieves a lighting device producing a luminous output of excellent intensity.

Preferably, at least some of the first focal points coincide inside said reflective conical central section in order to improve the uniformity of the luminous output of the lighting device. More preferably, at least some of the first focal points coincide with a focal point of the reflective conical central section.

In an embodiment, the solid state lighting elements comprise solid state lighting elements having different colours or colour points. This can be used to accurately tune the colour point of the lighting device, because excellent mixing of the luminous output of the various solid state lighting elements of the lighting device is achieved by the reflective element.

The position of the reflective conical central section may be manually adjustable such that the position of the reflective conical central section can be defined prior to the assembly of the lighting device.

In an alternative embodiment, the reflective conical central section is cooperatively coupled to an electromotor, said electromotor being responsive to a controller comprising a receiver for receiving a control signal for controlling said electromotor. Although this adds to the cost of the lighting device, an extremely versatile lighting device is obtained for which the optical characteristics may be adjusted in use, such that a single lighting device may be used for multiple applications.

The receiver may be a wireless receiver for receiving a wireless control signal for controlling said electromotor. This allows for the adjustment of position of the reflective conical central section using e.g. a wireless remote control.

According to another aspect, there is provided a lighting kit comprising the lighting device including the electromotor and a separate controller for producing said control signal. Such a separate controller may for instance be integrated in a lighting switch and arranged to provide the lighting device with the control signal over an electrically conductive wire between the lighting switch and the lighting device or instead may be a wireless controller such as a remote control device.

According to yet another aspect, there is provided a luminaire comprising the lighting device according to an embodiment of the present invention. Such a luminaire may for instance be a holder of the lighting device or an apparatus into which the lighting device is integrated.

### BRIEF DESCRIPTION OF THE EMBODIMENTS

Embodiments of the invention are described in more detail and by way of non-limiting examples with reference to the accompanying drawings, wherein:

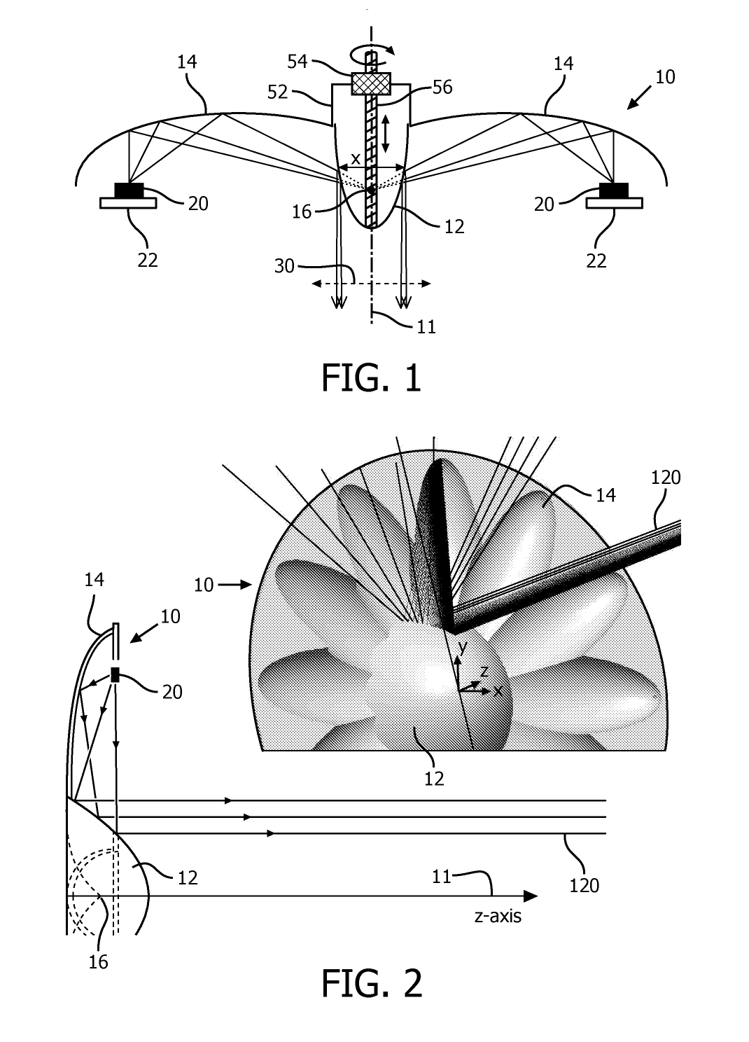

FIG. 1 schematically depicts a lighting device according to an embodiment of the present invention;

FIG. 2 schematically depicts an optical model of the lighting device of FIG. 1;

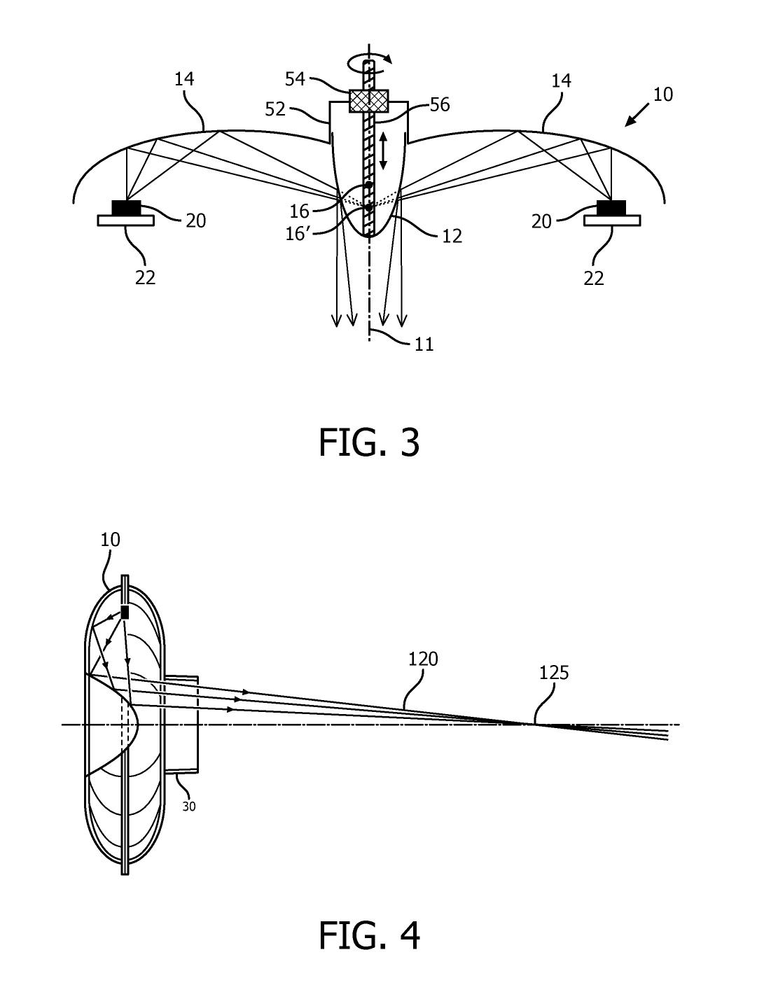

FIG. 3 schematically depicts the lighting device of FIG. 1 in an adjusted configuration;

FIG. 4 schematically depicts an optical model of the lighting device of FIG. 3;

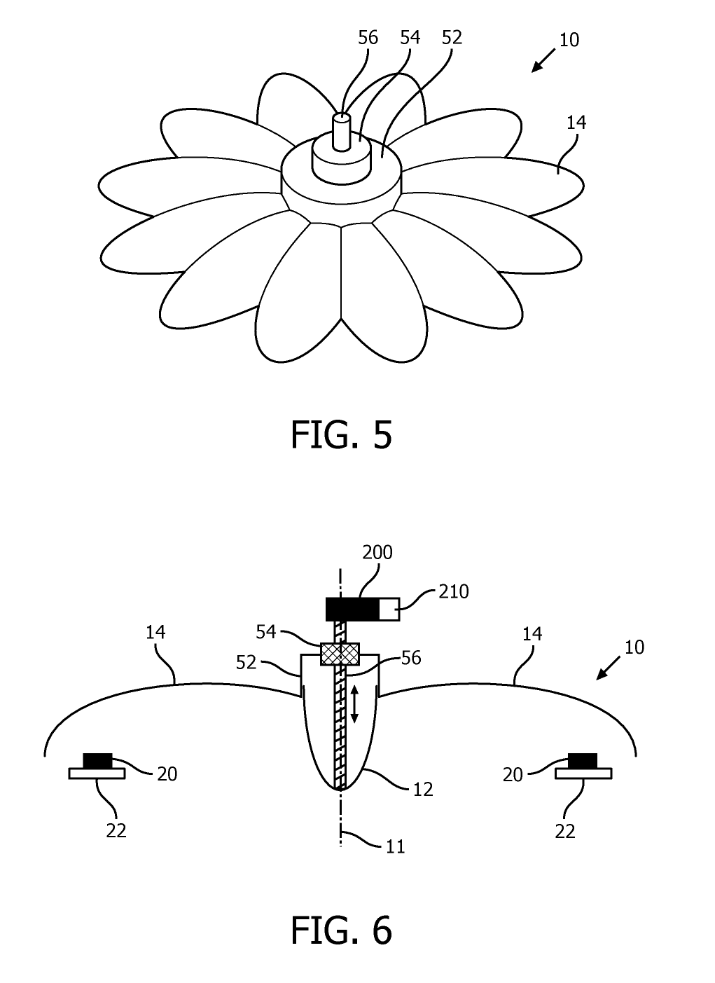

FIG. 5 schematically depicts an aspect of a lighting device according to an embodiment of the present invention;

FIG. 6 schematically depicts a lighting device according to yet another embodiment of the present invention;

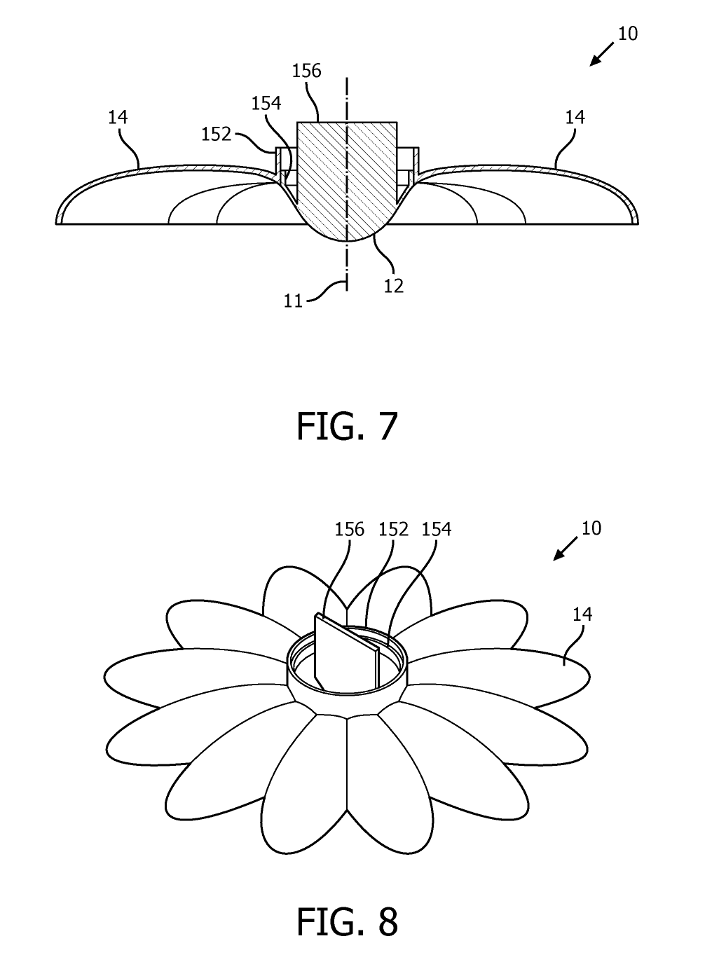

FIG. 7 schematically depicts another aspect of a lighting device according to an embodiment of the present invention;

FIG. 8 schematically depicts yet another aspect of a lighting device according to an embodiment of the present invention;

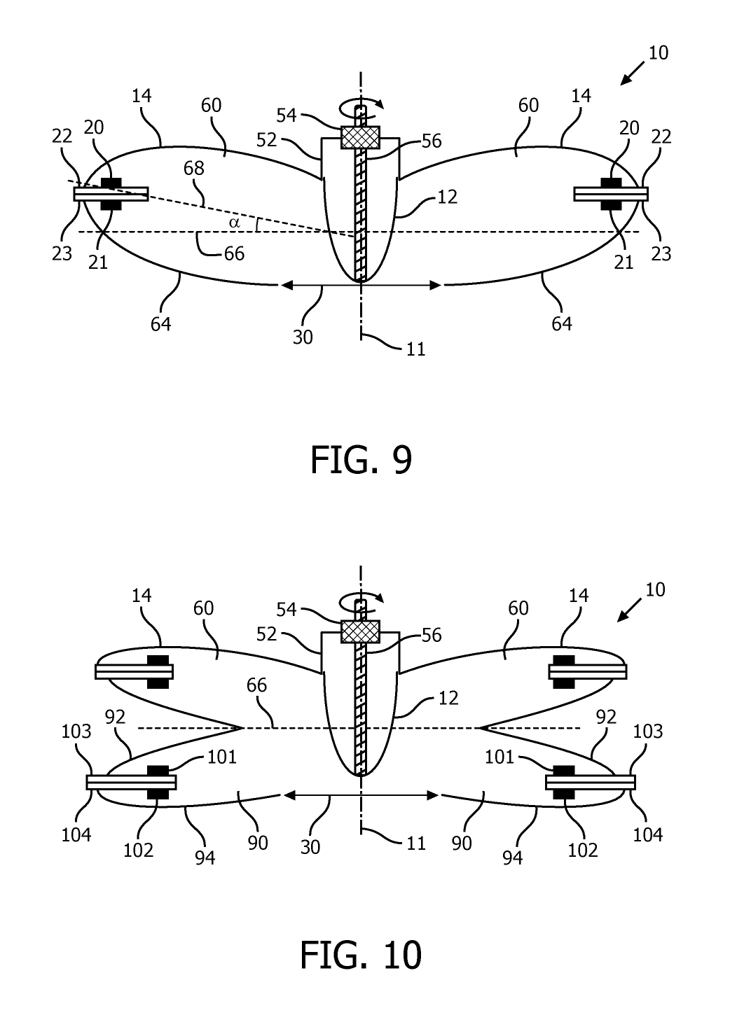

FIG. 9 schematically depicts a lighting device according to a further embodiment of the present invention; and

FIG. 10 schematically depicts a lighting device according to yet another embodiment of the present invention.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

FIG. 1 schematically depicts a cross-section of a lighting device according to an embodiment of the present invention. The lighting device comprises a reflective element 10 comprising a reflective convex conical central section 12, which may have a conic constant in the range of −0.7 to −1.3. The conic constant, which is also known as the Schwarzschild constant, defines the eccentricity of the conical central section 12. The conic constant may be expressed by the following formula in the x,y plane:

y²−2Rx+(K+1)x²=0

in which R is the radius of the curvature at x=0 and K is the conic constant. The reflective element 10 further comprises an array of reflective ellipsoid surfaces around the reflective conical central section 12, which surfaces extend radially away from said reflective conical central section 12. Two reflective ellipsoid surfaces 14 that each radially extend outwardly from the reflective conical central section 12 are shown in FIG. 1 are shown by way of non-limiting example. The reflective conical central section 12 and the respective reflective ellipsoid surfaces 14 may be individually realized in any suitable reflective material, e.g. a polymer material such as polycarbonate covered with a reflective coating such as optical grade silver or aluminium. The polymer material may be a composite polymer material. For instance, the composite polymer material may include up to 20% by weight of glass fiber to improve the thermal characteristics of the material, e.g. reduce the thermal expansion coefficient of the material. Specifically, the polymer material may be polycarbonate optionally comprising up to 20% by weight of glass fiber.

The reflective ellipsoid surfaces 14 are arranged relative to the reflective conical central section 12 such that each reflective ellipsoid surface 14 creates a first focal point inside the reflective conical central section 12 and a second focal point outside the reflective conical central section 12.

In an embodiment, at least some of the first focal points of the respective reflective ellipsoid surfaces 14 may coincide in point 16 within the reflective conical central section 12. In an embodiment, point 16 is the focal point of the reflective conical central section 12. Preferably, all of the first focal points of the respective reflective ellipsoid surfaces 14 coincide in a focal point 16 of the reflective conical central section 12.

Respective solid state lighting (SSL) elements 20, which may be mounted on a carrier 22, which may be a single carrier on may be respective carriers 22, are placed at the various second focal points of the reflective ellipsoid surfaces 14 and are arranged such that each of the SSL elements 20 faces the reflective ellipsoid surface corresponding to the second focal point at which the solid state lighting element 20 is placed. In an embodiment, the SSL elements 20 are light-emitting diodes (LEDs), e.g. semiconductor LEDs such as organic or inorganic semiconductor LEDs.

Due to the ellipsoid nature of the reflective ellipsoid surfaces 14 and the placement of the SSL elements 20 at the respective second focal points of these reflective ellipsoid surfaces 14, the luminous output of the SSL elements 20 is redirected by the reflective ellipsoid surfaces 14 towards the respective first focal points of the reflective ellipsoid surfaces 14, which lie within the reflective conical central section 12. This ensures that substantially all of the luminous output of the SSL elements 20 is redirected onto the convex surface of the reflective conical central section 12. In other words, the reflective element 10 forms a confocal reflective element 10 in which the first reflection is provided by the reflective ellipsoid surfaces 14 and the second reflection is provided by the reflective conical central section 12.

Due to the conic constant in the range of −0.7 to −1.3 of the reflective conical central section 12, a highly collimated luminous output may be generated by the reflective conical central section 12, in particular when the respective first focal points of the reflective ellipsoid surfaces 14 coincide with the focal point 16 of the reflective conical central section 12. The reflective conical central section 12 redirects the luminous output of the SSL elements 20 through an exit window 30 of the lighting device, which exit window 30 is arranged opposite the reflective conical central section 12 of the reflective element 10. This is explained in more detail with the aid of FIG. 2.

FIG. 2 depicts an optical model of a lighting device of the present invention, in which the reflective element 10 comprises a convex conical central section 12 around which an array of ellipsoid reflective surfaces 14 radially extend outwardly, i.e. towards the perimeter of the lighting device, thus yielding a flower-shaped reflective element 10. SSL elements 20 are placed at each second focal point of the respective ellipsoid reflective surfaces 14 with the first focal points of the respective ellipsoid reflective surfaces 14 being located within the convex conical central section 12 as previously explained. In FIG. 2, it is shown by way of non-limiting example that the respective first focal points coincide in focal point 16, which may be the focal point of the conical central section 12 as previously explained.

The confocal arrangement of the reflective element 10 ensures that the luminous output 120 generated by the SSL elements 20 exits the lighting device in a highly collimated fashion, i.e. substantially parallel to the z-axis shown in FIG. 2, which is the central axis of symmetry 11 of the lighting device and of the convex conical central section 12 of the reflective element 10. In an embodiment, the convex conical central section 12 is a paraboloid, i.e. has a conic constant of −1, which yields particularly high collimation of the luminous output 120.

In the lighting device shown in FIG. 1, the reflective conical central section 12 is movably mounted on the central axis 11 of the lighting device. To this end, the reflective conical central section 12 may be mounted on a central threaded screw shaft 56 on the central axis 11 of the lighting device, which central threaded screw shaft 56 mates with a threaded nut 54 mounted in the lighting device. In the embodiment shown in FIG. 1, the threaded nut 54 forms part of a central portion 52 of the reflective arrangement from which the ellipsoid reflective surfaces 14 extend although it should be understood that the nut 54 may be mounted in the lighting device in any suitable manner. This allows for the adjustment of the position of the reflective conical central section 12 relative to the ellipsoid reflective surfaces 14 by turning the threaded screw shaft 56 in a clockwise or counter-clockwise direction. Such an adjustment of the position of the reflective conical central section 12 relative to the ellipsoid reflective surfaces 14 may be made to adjust the luminous profile produced by the lighting device.

For instance, by adjusting the position of the reflective conical central section 12, the first focal points of the ellipsoid surfaces 14 may be moved out of the central focal point 16 of the reflective conical central section 12 such that the beam shape, e.g. the degree of collimation, of the luminous output of the lighting device is altered. This is shown in FIG. 3, in which the position of the reflective conical central section 12 is adjusted compared to its position in FIG. 1 by moving the reflective conical central section 12 upwardly along the central axis 11.

As shown in FIG. 4, this may for instance be used to create a luminous output 120, having a focal point 125, which focal point may be formed at different distances from the lighting device by adjustment of the position of the reflective conical central section 12. It is of course equally feasible to create a divergent luminous output, e.g. a wide beam angle luminous output by moving the reflective conical central section 12 along the central axis 11 in an opposite direction, e.g. downwards instead of upwards.

FIG. 5 schematically depicts a perspective view of the reflective arrangement 10 as used in the lighting device of FIGS. 1 and 3. The reflective arrangement has a flower-like shape in which the plurality of ellipsoid surfaces 14 forms the petals of the flower. The ellipsoid surfaces 14 are mounted on the central section 52 that further comprises the threaded nut 54. The central threaded screw shaft 56 mating with the threaded nut 54 is also shown.

At this point, it is explained that the relative position of the reflective conical central section 12 may be adjusted manually prior to assembly of the lighting device, e.g. by turning the central threaded screw shaft 56 to its desired position, in order to select the desired luminous output profile such as the intended beam angle or beam shape of the lighting device.

It is however equally feasible that the relative position of the reflective conical central section 12 is adjusted electrically. An example embodiment of such a lighting device is shown in FIG. 6. The lighting device shown in FIG. 6 is identical to the lighting device shown in FIG. 1 and FIG. 3 such that the features shown in FIG. 6 that have already been described in FIG. 1 and FIG. 3 will not be described again for the sake of brevity. In addition, the lighting device shown in FIG. 6 comprises an electromotor 200 that is cooperatively coupled to the central threaded screw shaft 56 and is responsive to a controller 210. The controller 210 may be a separate controller or may be integrated in the electromotor 200.

The controller 210 is arranged to receive a control signal for adjusting the position of the reflective conical central section 12 and to translate this control signal into a further control signal for controlling the electromotor 200 such that the electromotor 200 adjusts the position of the central threaded screw shaft 56 in accordance with the control signal received by the controller 210.

The controller 210 may be arranged to receive the control signal over a wire, which may be one of the power supply wires to which the lighting device is coupled in operation. The control signal may for instance be provided in the form of a modulation of the electrical current provided to the lighting device, as is well-known per se, e.g. from Ethernet over power protocols. Alternatively, the lighting device in operation may be conductively coupled to a dedicated control wire for providing the lighting device with the control signal.

The control signal may be generated in any suitable manner. For instance, a (wall-mounted) lighting switch may comprise an additional button or knob for adjusting the position of the reflective conical central section 12, which button or knob is adapted to generate the control signal upon being engaged. The generation of control signals in this manner is of course well-known per se and will not be discussed in further detail for the sake of brevity.

In an alternative embodiment, the controller 210 may comprise a receiver or transceiver for wirelessly receiving the control signal. In this embodiment, the control signal may for instance be generated using a remote control, as is well-known per se. This may be a dedicated remote control or any suitable electronic device that can be adapted to act as a remote control, e.g. a mobile communications device such as a mobile phone. Any suitable communication protocol may be used to wirelessly communicate the control signal from the remote control to the controller 210, e.g. Bluetooth is a non-limiting example of a suitable wireless communication protocol.

The inclusion of the electromotor 200 and the controller 210 in the lighting device allows for a single lighting device to produce different luminous output profiles such as the different beam angles or beam shapes. Although the presence of the electromotor 200 and the controller 210 increases the cost of the lighting device, at the same time it improves the versatility of the lighting device such that a cost-effective versatile lighting device is obtained.

Embodiments of the lighting device including the electromotor 200 and the controller 210 may be sold as a lighting kit together with their separate controller, e.g. the (wall-mountable) lighting switch including the additional control button or the remote control in case of a wirelessly controlled lighting device.

At this point, it should be understood that the reflective conical central section 12 may be movably mounted on the central axis 11 of the lighting device in any suitable manner. A cross-section of an alternative embodiment of the reflective arrangement 10 is schematically shown in FIG. 7, whilst FIG. 8 schematically depicts a perspective view of this alternative embodiment. In this embodiment, the ellipsoid surfaces 14 extend from a central body having a first threaded surface portion 152 facing the central axis of the lighting device. The reflective conical central section 12 in this embodiment comprises a second threaded surface portion 154 on its outer surface that engages with the first threaded circuit portion 152, such that the relative position of the reflective conical central section 12 can be adjusted by twisting the reflective conical central section 12 into or out of the central body.

In order to facilitate this twisting action, the reflective conical central section 12 may further comprise an attachment 156 mounted inside the reflective conical central section 12 to facilitate the twisting of the reflective conical central section 12. This attachment 156 for instance may have any suitable shape that makes it easier for a user to manually adjust the relative position of the reflective conical central section 12. In FIGS. 7 and 8, this shape is shown to be a plate by way of non-limiting example only.

At this point, it is noted that the annular reflective body around the reflective conical central section 12 including the ellipsoid reflective surfaces 14 may have any suitable number of such reflective surfaces, which surfaces may be arranged in a single plane of in multiple planes.

An example embodiment of a reflective arrangement 10 comprising ellipsoid reflective surfaces 14 in multiple planes is shown in FIG. 9, which schematically depicts a cross-section of a lighting device according to another embodiment of the present invention having an increased luminous output 120 compared to the lighting device of FIG. 1. In FIG. 9, the reflective arrangement 10 may comprise an array of ellipsoid bodies 60 around the convex conical central section 12 that radially extend outwardly from the central portion 52. As before, the convex conical central section 12 may have a conic constant in the range of −0.7 to −1.3 in some embodiments. Each of the reflective ellipsoid bodies 60 comprises a reflective ellipsoid surface 14 as shown in FIG. 1 as well as a further reflective ellipsoid surface 64 opposite the reflective ellipsoid surface 14. Each further reflective ellipsoid surface 64 is arranged to create a first focal point inside the reflective conical central section 12 and a second focal point outside the reflective conical central section 12.

The respective first focal points of the further reflective ellipsoid surface 64 may coincide inside the reflective conical central section 12. In an embodiment, the further reflective ellipsoid surfaces 64 are separated from each other by an exit window 30 opposite the reflective conical central section 12. The exit window 30 may be a circular exit window.

Further solid state lighting elements 21 are located at the second focal point of each of the further reflective ellipsoid surfaces and arranged to emit light towards said further reflective ellipsoid surface 64. In other words, the luminous surfaces of the further solid state lighting elements 21 face the further reflective ellipsoid surface 64. The respective solid state lighting elements 21 may be mounted on a further carrier 23, which may be a single carrier or respective carriers. As before, the further solid state lighting elements 21 may contain a mixture of different colour SSL elements, e.g. red and white LEDs, different colour temperature white LEDs and so on as previously explained. The carrier 22 may be separated from the further carrier 23 by a heat sink (not shown) to further improve the heat dissipation of the lighting device.

In FIG. 9, the position of the reflective ellipsoid bodies 60 is further defined by an angle α relative to the X-Y plane 66 of the lighting device. For the avoidance of doubt, the X-Y plane is the plane perpendicular to the central axis 11 of the lighting device. The angle α is defined as the angle between the central plane 68 between the reflective ellipsoid surface 14 and the further reflective ellipsoid surface 64 and the X-Y plane 66.

In an embodiment (not shown), α=0°, in which case the central plane 68 coincides with the X-Y plane 66. Alternatively, α≠0°, in which case the reflective ellipsoid bodies 60 are tilted out of the X-Y plane 66, such that the respective first focal points of the reflective ellipsoid surfaces 14 and the further reflective ellipsoid surfaces 64 are translated along the Z-axis in the direction of the vertex of the reflective conical central section 12. This effectively reduces the beam width of the luminous output 120, which for instance may reduce spatial colour separation and therefore improves the perception of colour mixing by the reflective arrangement 10 of the lighting device. In an embodiment, the angle α may be chosen in the range of 1-10°. Although higher angles are feasible, it has been found that the luminous output of the lighting device is reduced at these higher angles due to absorption of the generated light by the carriers 22, 23.

Yet another embodiment of such a reflective arrangement 10 is shown in FIG. 10, in which the reflective arrangement 10 comprises the first annular array of first reflective bodies 60 and further comprises a second annular array of second reflective bodies 90. The second reflective bodies 90 include a third reflective ellipsoid surface 92 that generate a fifth focal point within the reflective conical central section 12, which fifth focal points preferably coincide with each other, as previously explained.

The third ellipsoid reflective surfaces 92 further generate a sixth focal point at which a third group of SSL elements 101 are located. The second reflective bodies 90 further include a fourth reflective ellipsoid surface 94 that generates a seventh focal point within the reflective conical central section 12, which seventh focal points preferably coincide with each other, as previously explained. The fourth reflective ellipsoid surfaces 94 further generate an eighth focal point at which a fourth group of SSL elements 102 are located.

The first, third, fifth and seventh focal points within the reflective conical central section 12 preferably coincide with each other or are at least spatially separated from each other by as small as possible distance to optimize the color mixing characteristics of the lighting device. In an embodiment, the first group of SSL elements 20 may comprise the same colour or different colour SSL elements as previously explained.

In an embodiment, the second group of SSL elements 21 may comprise the same colour or different colour SSL elements as previously explained. In addition, the colours of the second group of SSL elements 21 may be the same as or different to the colours of the first group of SSL elements 20.

In an embodiment, the third group of SSL elements 101 may comprise the same colour or different colour SSL elements as previously explained. In addition, the colours of the third group of SSL elements 101 may be the same as or different to the colours of the second group of SSL elements 21, and/or may be the same as or different to the colours of the first group of SSL elements 20.

In an embodiment, the fourth group of SSL elements 102 may comprise the same colour or different colour SSL elements as previously explained. In addition, the colours of the fourth group of SSL elements 102 may be the same as or different to the colours of the third group of SSL elements 101, and/or may be the same as or different to the colours of the second group of SSL elements 21, and/or may be the same as or different to the colours of the first group of SSL elements 20.

In the embodiments in FIG. 9 and FIG. 10, the reflective conical central section 12 is again movably mounted on the central axis 11 of the lighting device. The reflective conical central section 12 may be mounted on a central threaded screw shaft 56 on the central axis 11 of the lighting device, which central threaded screw shaft 56 mates with a threaded nut 54 mounted in the lighting device. In the embodiment shown in FIG. 9, the threaded nut 54 forms part of a central portion 52 of the reflective arrangement from which the ellipsoid reflective surfaces 14 extend although it should be understood that the nut 54 may be mounted in the lighting device in any suitable manner. It should further be understood that the lighting devices shown in FIGS. 9 and 10 may further comprise an electromotor and controller as shown in FIG. 6. It is of course equally feasible that the reflective conical central section 12 is movably mounted in FIGS. 9 and 10 using the reflective arrangement as shown in FIGS. 7 and 8, or indeed in any other suitable manner.

The lighting device according to embodiments of the present invention may be a light bulb, more preferably a spot light bulb. The lighting device according to embodiments of the present invention may be advantageously included in a luminaire such as a holder of the lighting device, e.g. a ceiling light fitting, or an apparatus into which the lighting device is integrated, e.g. a cooker hood or the like.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A lighting device comprising:
a solid state lighting element;
a reflective arrangement for reflecting luminous output of the solid state lighting element, the reflective arrangement comprising:
a reflective conical central section on a central axis of the lighting device; and
an annular reflective body around the reflective conical central section, said body comprising an ellipsoid surface having a first focal point lying inside the reflective conical central section and a second focal point, wherein the solid state lighting element is located at the second focal point; and
wherein the reflective conical central section is movably mounted along said central axis;
wherein the annular reflective body comprises an annular array of reflective ellipsoid surfaces extending radially from said reflective conical central section, each reflective ellipsoid surface having a first focal point inside the reflective conical central section and a second focal point; and
the lighting device comprises a plurality of solid state lighting elements, each solid state lighting element being located at a respective one of said second focal points, and arranged to emit light towards said reflective ellipsoid surface.

2. The lighting device of claim 1, wherein the annular reflective body comprises a screw nut on the central axis, and wherein the central conical section comprises a screw shaft mating with said screw nut.

3. The lighting device of claim 1, wherein the annular reflective body comprises a first threaded surface portion facing the central axis and wherein the reflective conical central section comprises a second threaded surface portion engaging with the first threaded circuit portion, the reflective conical central section further comprising an attachment mounted inside the reflective conical central section for twisting the reflective conical central section.

4. The lighting device of claim 1, wherein the reflective conical central section has a conic constant in the range of −0.7 to −1.3.

5. The lighting device of claim 1, wherein the reflective conical central section has a convex surface such as a parabolic surface.

6. (canceled)

7. The lighting device of claim 1, wherein the annular reflective body comprises an array of ellipsoid bodies, each body comprising:
one of said reflective ellipsoid surfaces; and
a further reflective ellipsoid surface opposite the reflective ellipsoid surface, said further reflective ellipsoid surface creating a first focal point inside the reflective conical central section and a second focal point;
the lighting device further comprising a solid state lighting element located at the second focal point of each of the further reflective ellipsoid surfaces and arranged to emit light towards said further reflective ellipsoid surface.

8. The lighting device of claim 7, wherein said ellipsoid bodies are angled relative to a plane perpendicular to said central axis.

9. The lighting device of claim 8, wherein the annular reflective body further comprises an annular array of further ellipsoid bodies angled relative to said plane, the ellipsoid bodies and further ellipsoid bodies being on opposite sides of said plane, each further ellipsoid body comprising:
a first reflective ellipsoid surface creating a first focal point inside said reflective conical central section and a second focal point; and
a second reflective ellipsoid surface opposite the first reflective ellipsoid surface, said second reflective ellipsoid surface creating a first focal point inside said reflective conical central section and a second focal point;
the lighting device further comprising:
a solid state lighting element located at the second focal point of each of said first reflective ellipsoid surfaces and arranged to emit light towards said first reflective ellipsoid surface; and a solid state lighting element located at the second focal point of each of said second reflective ellipsoid surfaces and arranged to emit light towards said second reflective ellipsoid surface.

10. The lighting device of claim 1, wherein at least some of the first focal points coincide inside said reflective conical central section.

11. The lighting device of claim 6, wherein the plurality of solid state lighting elements comprises solid state lighting elements having a different colour or different colour points.

12. The lighting device of claim 1, wherein the reflective conical central section is cooperatively coupled to an electromotor, said electromotor being responsive to a controller comprising a receiver for receiving a control signal for controlling said electromotor.

13. The lighting device of claim 12, wherein the receiver is a wireless receiver for receiving a wireless control signal for controlling said electromotor.

14. A lighting kit comprising the lighting device of claim 12 and a separate controller for producing said control signal.

15. A luminaire comprising the lighting device of claim 1.
